(19) United States
(12) Patent Application Publication
(10) Pub. No.: US 2025/0243942 A1
(43) Pub. Date: Jul. 31, 2025

(54) TWO-WAY WIRELESS CONTROL OF DIGITALLY CONTROLLED VALVE ACTUATORS IN A POOL OR SPA SYSTEM

(71) Applicant: Zodiac Pool Systems LLC, Carlsbad, CA (US)

(72) Inventors: Minas Minassian, Carlsbad, CA (US); Mark J. Bauckman, San Marcos, CA (US); Darin Eames, Carlsbad, CA (US); Jeremy Young, Carlsbad, CA (US)

(73) Assignee: Zodiac Pool Systems LLC, Carlsbad, CA (US)

(21) Appl. No.: 19/028,781

(22) Filed: Jan. 17, 2025

Related U.S. Application Data
(60) Provisional application No. 63/625,148, filed on Jan. 25, 2024.

(51) Int. Cl. F16K 31/02; E04H 4/12; G05D 7/06

(52) U.S. Cl. CPC F16K 31/02; E04H 4/12; G05D 7/0635

(57) ABSTRACT

Systems and methods for two-way wireless control of digitally controlled valve actuators in a pool or spa system are disclosed. In an example method for actuating a valve included in a pool or spa system, a pool automation system outputs, using a first wireless interface of the pool automation system, a first wireless signal to a valve actuator operably connected to the valve, the first wireless signal received at a second wireless interface of the valve actuator and including a position change signal configured to cause the valve actuator to actuate the valve from a previous position to a new position. The pool automation system receives, from the valve actuator, by the first wireless interface of the pool automation system, a second wireless signal including valve position state information relating to the new position of the valve.

### CROSS-REFERENCE TO RELATED APPLICATION

This application claims priority to provisional application U.S. Ser. No. 63/625,148 entitled “TWO-WAY WIRELESS CONTROL OF DIGITALLY CONTROLLED VALVE ACTUATORS IN A POOL OR SPA SYSTEM” and filed on Jan. 25, 2024, the entire disclosure of which is incorporated herein by reference for any purpose.

### FIELD

The present disclosure relates generally to valves for pool or spa systems and more particularly, although not exclusively, to remotely controlled valves using two-way wireless communications via wireless interfaces.

### BACKGROUND

Pool and spa systems typically use valves to manage water levels and route water between features. In some scenarios, valves may be remotely operated using valve actuators that use motors and/or gears to move the valve among various positions by, for example, applying torque to a valve stem. In some examples, valve actuators can be digitally controlled, which may be networked with other components using hardwired connections. Such digitally controlled valve actuators may be constrained by only enabling setting of a limited number of preset hardcoded or hardwired valve positions. Use of hardwired connections or hardcoded/hardwired valve positions may present challenges and limitations, especially for operators and installers of pool and spa systems.

### SUMMARY

In one general aspect, a method for actuating a valve included in a pool or spa system, includes outputting, by a pool automation system using a first wireless interface of the pool automation system, a first wireless signal to a valve actuator operably connected to the valve, the first wireless signal received at a second wireless interface of the valve actuator and including a position change signal configured to cause the valve actuator to actuate the valve from a previous position to a new position. The method further includes receiving, from the valve actuator, by the first wireless interface of the pool automation system, a second wireless signal including valve position state information relating to the new position of the valve.

In another general aspect, a pool automation system for controlling a valve position of a valve included in a pool or spa system includes a first wireless interface; one or more non-transitory computer-readable media; and one or more processors communicatively coupled to the one or more non-transitory computer-readable media, the one or more processors configured to execute processor-executable instructions stored in the non-transitory computer-readable media to perform operations including outputting, using the first wireless interface, a first wireless signal to a valve actuator operably connected to the valve, the first wireless signal received at a second wireless interface of the valve actuator and including a position change signal configured to cause the valve actuator to actuate the valve from a previous position to a new position. The operations further include receiving, from the valve actuator, by the first wireless interface, a second wireless signal including valve position state information relating to the new position of the valve.

In another general aspect, a method for actuating a valve included in a pool or spa system, includes receiving, by a first wireless interface of a valve actuator from a pool automation system, a first wireless signal including a position change signal, the valve actuator operably connected to the valve. The method further includes actuating the valve from a previous position to a new position based on the position change signal. The method further includes outputting, by the first wireless interface of the valve actuator to the pool automation system, a second wireless signal including valve position state information relating to the new position of the valve.

### BRIEF DESCRIPTION OF THE DRAWINGS

FIG. 1 illustrates a pool or spa system, according to at least one example.

FIG. 2 illustrates a user device including an example user interface for configuring a valve actuator, according to at least one example.

FIG. 3 illustrates an example flow diagram showing a process for two-way wireless control of digitally controlled valve actuators in a pool or spa system, according to at least one example.

FIG. 4 shows a process for configuring stop locations at a valve actuator based on user inputs, according to at least one example.

FIG. 5 shows another process for two-way wireless control of digitally controlled valve actuators in a pool or spa system, according to at least one example.

FIG. 6 illustrates a valve actuator with a valve position sensor, according to at least one example.

FIG. 7 illustrates an exemplary pool plumbing layout, according to at least one example.

FIG. 8 illustrates examples of components of a computer system, according to at least one example.

### DETAILED DESCRIPTION

Examples described herein relate to systems, devices, and techniques for remotely controlling pool valves using wireless communications. Pool or spa systems typically include a number of valves for use during normal operations and maintenance. For example, diverter valves can be used to allow water to be routed between different circuits. Ball valves and gate valves can provide stop and start flow to different components, such as during maintenance to isolate parts of the system. Manual control of such valves may be inconvenient or involve significant expenditures of time and labor, particularly when the valves are difficult to access (e.g., buried or blocked by other equipment). Consequently, valves integrated with pool or spa systems can be remotely actuated using valve actuators.

A valve actuator can refer generally to a mechanically coupled component that can automate the operation of a valve by mechanically moving its components, such as the valve handle or other internal mechanism, to open, close, or adjust flow without manual intervention. Valve actuators can interface with, for example, diverter valves, enabling automated switching between pool and spa modes, activating water features, or adjusting water flow to heaters, filters, or other equipment. A valve actuator may be powered by electricity, pneumatically, hydraulically, or via other suitable motive force.

In some existing pool or spa systems, valve actuators can be remotely controlled using a pool automation system. For example, valve actuators may be powered from a power distribution panel and communicatively coupled with a pool automation system, that may have additional features enabling seamless integration with programmable schedules or user input through a control panel or mobile app. By eliminating the need for manual operation, valve actuators enhance convenience, efficiency, and the overall user experience, especially in complex systems with multiple control points. Actuated valves, controlled by automation systems, can enable features like switching between pool and spa modes or activating waterfalls.

Some existing valve actuators may be controlled from the pool automation system using analog electrical signals. For example, an analog electrical signal may be used to control the valve actuator motor, causing it to rotate the valve to a specific position. The analog electrical signal can be applied to electrical terminals at the valve actuator to control relays or other switching mechanisms. In some examples, the valve actuators may be controlled using a wireless signal using, for example, a serial RS-485 interface.

Remote control of valve actuators using a hardwired analog or digital connection involves a number of challenges, however. Installation of wires can be labor-intensive and costly, particularly for retrofits, as running cables to each actuator increases complexity. Physical connections may be prone to damage from environmental factors such as water, corrosion, or wear. Hardwired physical connections can limit scalability due to the added burden associated with adding or reconfiguring actuators. Further, maintenance of hardwired actuators can be cumbersome and introduce an additional dimension to fault tracing that can be difficult to troubleshoot in practice for underwater or buried wires.

Systems and methods for implementing two-way wireless control of digitally controlled valve actuators in a pool or spa system are disclosed to address these challenges. To communicate with the valve actuator, the pool automation system may send a wireless signal over a wireless network to a wireless interface of the valve actuator. In addition to the wireless interface, the valve actuator may include any suitable onboard electronics (e.g., a controller including, for example, a microprocessor, memory, etc.) and any suitable onboard mechanical actuator (e.g., an electric servo motor, etc.). The onboard electronics may process the wireless signal and the onboard actuator may actuate the pool valve (e.g., open or close the valve). In some examples, the wireless signal may include a control signal to direct the valve actuator to actuate the pool valve a specific amount, to a predefined location, and/or according to any other suitable stop location. In some examples, the pool automation system may calculate (or reference such as in a lookup table) an appropriate degree of openness for a desired outcome (e.g., desired flowrate, operation, etc.), and may send the signal on the wireless network for the valve actuator to actuate the pool valve the appropriate degree.

The valve actuator may in turn be able to report the valve position before, during, or after actuation, and may be able to report what operation results from each available position. For example, the valve actuator may be able to report that, at a first position, the valve will allow a first flow rate (e.g., 80 gallons per minute) and, at a second position, the valve will allow a second flow rate (e.g., 50 gallons per minute). The pool automation system and the valve actuator may be able to communicate with each other to achieve a result or particular outcome, which may be represented in terms of openness, degrees, preset locations, preset operations (e.g., a setting for a high fountain height, a setting for a medium fountain height, a setting for a low fountain height, etc.), or other result.

A user (e.g., a pool technician) may use a user device, such as a smartphone or tablet running a specialized application, to connect to the valve actuator (e.g., via the wireless interface) and/or connect to the pool automation system to establish one or more stop locations for the valve. This may include the user accessing a user interface that corresponds to the valve and digitally represents information about the valve. Achieving an operation by two-way wireless communication between the valve actuator and the pool automation system may allow the user to avoid an otherwise tedious process of testing and retesting valve angles to determine which angles achieve which outcomes for the pool system.

In one example method for actuating a valve included in a pool or spa system, a pool automation system outputs, using a wireless interface, a wireless signal to a valve actuator operably connected to the valve which is received at a complementary wireless interface of the valve actuator. The wireless signal includes a position change signal that is configured to cause the valve actuator to actuate the valve from a previous position to a new position. For instance, the position change signal can cause the valve to transition from opened to closed or from 30% open to 60% open. The wireless interface of the pool automation system later receives, from the wireless interface of the valve actuator, another wireless signal including valve position state information relating to the new position of the valve. For example, the valve position state information may indicate that the valve has transitioned from opened to closed or from 30% open to 60% open as a result of the first wireless signal.

In addition to addressing the challenges described above, two-way wireless control of digitally controlled valve actuators in a pool or spa system has several more advantages that constitute improvements to the technical field of remote control of pool and spa systems. Two-way wireless control of valve actuators can improve system reliability by minimizing the risk of damage to hardwired components caused by environmental factors such as water exposure, corrosion, or wear. Maintenance operations can be performed more easily using wireless diagnostics or wireless fault-tracing capabilities, enabling operators to identify and address issues remotely. Furthermore, two-way communication can ensure accurate real-time feedback from valve actuators, allowing for precise control and monitoring of valve positions. Two-way wireless communication can likewise enable advanced functionality, such as customizable preset positions, adaptive flow control, and integration with user-friendly interfaces, such as mobile apps or control panels, for enhanced automation and user convenience.

These illustrative examples are given to introduce the reader to the general subject matter discussed herein and the disclosure is not limited to these examples. The following sections describe various additional non-limiting examples of systems and methods for two-way wireless control of digitally controlled valve actuators in a pool or spa system.

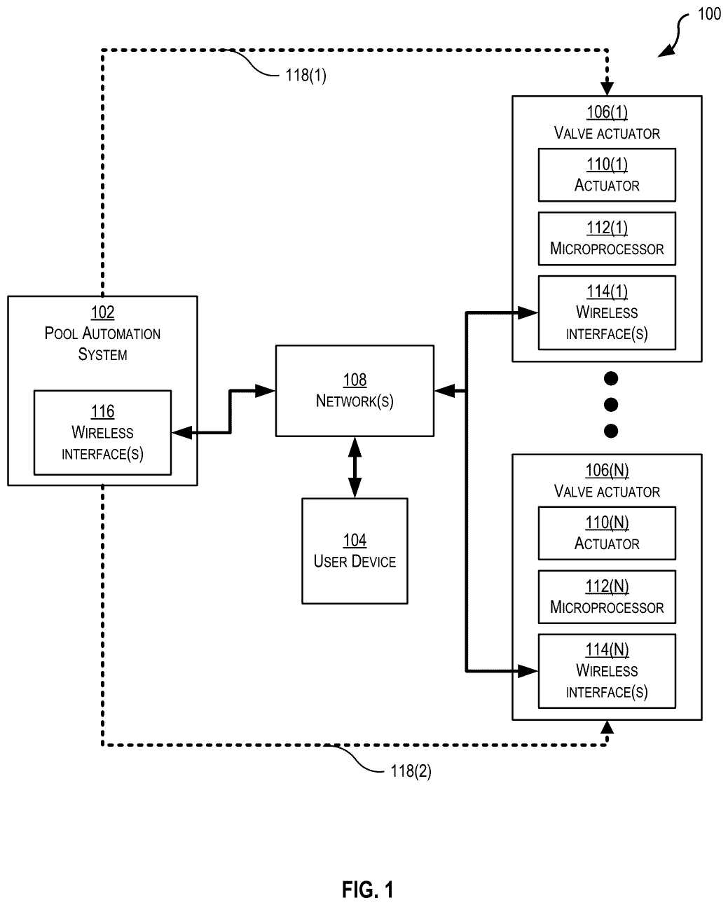

Turning now to the figures, FIG. 1 illustrates a pool or spa system 100, according to at least one example. The pool or spa system 100 may be configured to perform aspects of the techniques described herein. The pool or spa system 100 may include components that are suitable for controlling the operation of a pool system, a spa system, a water feature system, a sprinkler system, and/or any suitable combination of the foregoing.

The pool or spa system 100 includes a pool automation system 102, a user device 104, and one or more valve actuators 106(1)-106(N). The pool automation system 102 can be a computing system located in proximity to the pool or spa system 100 to effect centralized control of the pool or spa system 100. The pool automation system 102 can include a processing subsystem. The processing subsystem may include one or more processors that are communicatively coupled with a memory, such as physical, random-access memory or a hard disk drive. The memory can include one or more non-transitory computer-readable media that include processor-executable instructions to perform various operations for the control and operation of the pool automation system 102. The pool automation system 102 can execute software locally as well as access software or data stored on remote server or in cloud-hosted network locations.

Each valve actuator 106 may correspond to and be mechanically connected to a pool valve. As described herein, generally, the valve actuator 106 may be configured to operate the pool valve by opening and closing the valve. Any suitable number of valve actuators 106 may be included in a pool, spa, or other water system in which the pool or spa system 100 is deployed. This may result in the valve actuators 106 being physically spread out one from another. To effectively communicate with the valve actuators 106, the pool or spa system 100 may include one or more network(s) 108, which may be referred to herein as the network 108. The network 108 may be any suitable wireless communications network such as, for example, a Wi-Fi network, a cellular network, a Bluetooth (or other short-range wireless) network, and the like. In some examples, the network 108 may be part a homeowner's personal local area network and the pool automation system 102, the user device 104, and the valve actuators 106 may be configured to communicate via the local area network.

Turning now to the valve actuators 106, each valve actuator 106 may include a mechanical actuator 110, a microprocessor 112, and one or more wireless interface(s) 114. The mechanical actuator 110 may be mechanically coupled with the pool valve to mechanically operate the pool valve. In this manner, the mechanical actuator 110 may be any suitable pneumatic, hydraulic, solenoid, or other motor mechanism.

In some examples, the actuator 110 can be digitally controlled. For example, the actuator 110 may include an integrated microprocessor 112 capable of receiving digital commands or instructions via protocols such as one based on the serial RS-485 standard, Ethernet, or wireless communication standards such as Zigbee or Wi-Fi. These digital commands or instructions can be used to cause the valve to move to specified positions or other valve operations. In some examples, the actuator 110 may include sensors, such as position encoders or flow meters, that can provide feedback to the microcontroller or processor. The microprocessor 112 may be any suitable processor and memory chip configured to provide control instructions to the actuator 110 and process signals received from the wireless interfaces 114. The microprocessor 112 may be included as a single chip on a board with other electronics or as separate components on the same or different boards.

The wireless interfaces 114 may enable the valve actuator 106 to communicate wirelessly with the pool automation system 102, the user device 104, and/or other valve actuators 106. The wireless interfaces 114 may be selected depending on the application. For example, the wireless interfaces 114 may enable communication over Wi-Fi on the 802.11 family of standards, over cellular standards (e.g., 3G, 4G, LTE, 5G, and the like), over Bluetooth, and/or other wireless communication protocols and standards. To enable wireless communication with the valve actuators 106, the pool automation system 102 may also include one or more wireless interfaces 116. The wireless interfaces 116 may be the same or similar to the wireless interfaces 114. The wireless communications between the valve actuators 106, the user device 104, and the pool automation system 102 may be two-way, as illustrated by the bolded two-directional arrows connecting these components via the network 108.

While not shown in FIG. 1, the pool automation system 102 may also include other suitable electronics such as controllers, microprocessors, interfaces, and the like to enable the techniques described herein. For example, the pool automation system 102 may also include a user interface in the form of a display, physical interface, or the like for interacting with the valve actuators. In some examples, such interactions and user interfaces may be displayed on the user device 104, which may connect to the pool automation system 102 and/or the valve actuators 106 to perform the techniques described herein. In some examples, the user device 104 may connect to the pool automation system 102 and/or the valve actuators 106 via a local network. In some examples, such as when the pool automation system 102 enables a connection to a cloud server, the user device 104 may be configured to connect to the pool automation system 102 from a remote location. The user device 104 can be any type of device capable of executing the appropriate client software for interfacing with the pool automation system 102. For example, the user device 104 may be a laptop, desktop, smartphone, tablet, smartwatch, and so on.

The pool automation system 102, in some examples, may provide power to the valve actuators 106 via power lines 118(1) and 118(2). In some examples, the power lines 118 may be dedicated for providing power to the valve actuators 106 and/or may power other components around the valve actuators 106. In some examples, the valve actuators 106 may get power from outlets or other sources near the valve actuators 106. For example, electrical power may be supplied via power lines 118(1) and 118(2). The valve actuators 106 may be powered by alternating current (AC), direct current (DC), or a combination thereof as the electrical power requirements of the actuator 110 and electronic components may vary.

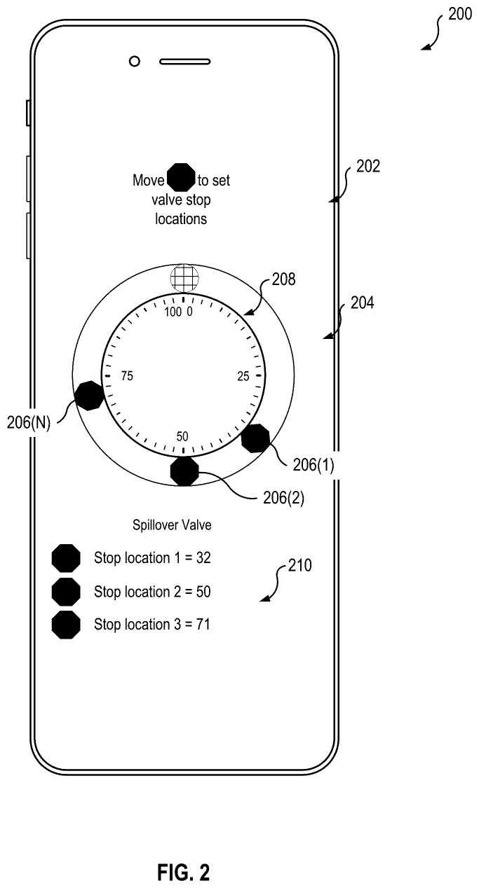

FIG. 2 illustrates a user device 200 including an example user interface 202 for configuring a valve actuator, according to at least one example. The user device 200 may be any suitable user device such as a laptop, smartphone, tablet, and the like. The user interface 200 may be operated by a user/owner of the pool system and/or by a pool technician. The user interface 202 may include a configuration element 204 and information area 210. The configuration element 204 may be used to configure stop locations 206(1)-206(N) represented by User Interface (UI) elements shown as octagons with respect to a dial indicator 208. A stop location may refer generally to a predefined position at which an actuator halts the valve's movement, such as fully open, fully closed, or any intermediate position. The stop locations 206 may represent stop locations for a valve called “Spillover Valve.” The user of the user device 200 may adjust the UI elements along the dial indicator 208 to specify where the valve will stop. The user may also add and remove additional UI elements to add/remove stop locations 206. The dial indicator 208 shows the stop locations from 1 to 100. Of course, other divisions such as degrees, portions, and the like would also be appropriate.

The information area 210 may include additional information about the stop locations 206. For example, stop location 206(1) may correspond to a value of 32 (out of 100), the stop location 206(2) may correspond to a value of 50 (out of 100), and the stop location 206(3) may correspond to a value of 71 (out of 100). In some examples, additional information may be included in the information area 210. For example, as each stop location 206 may correspond to a particular operation, setting, or feature, the information area 210 may include a description about the purpose for the stop location 206. As an example, the valve may be used to control the operation of a water feature and the stop locations 1-3 may correspond to different flow rates (and thereby different levels of a fountain in the water feature). The information area 210 may label these stops with descriptive language (or the user may input such information).

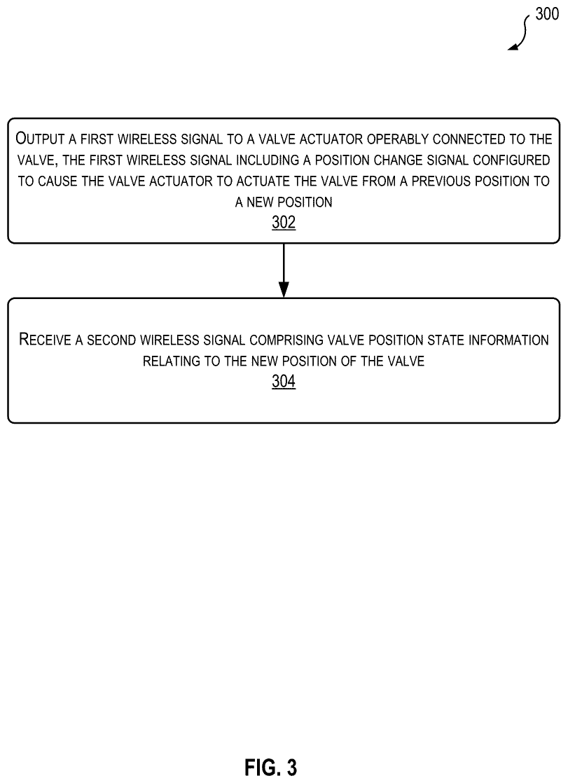

FIG. 3 illustrates an example flow diagram showing a process 300 for two-way wireless control of digitally controlled valve actuators in a pool or spa system, according to at least one example. The process 300, and any other process described herein (e.g., process 300, 400, and 500), are illustrated as a logical flow diagram, each operation of which represents a sequence of operations that may be implemented in hardware, computer instructions, or a combination thereof. In the context of computer instructions, the operations may represent computer-executable instructions stored on one or more non-transitory computer-readable storage media that, when executed by one more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the process.

Additionally, some, any, or all of the processes described herein (including the processes 400 and 500 below) may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 300 of FIG. 3 is for communicating with a valve actuator, according to at least one example. The process 300 may be performed by a pool automation system (e.g., the pool automation system 102 of FIG. 1) or other suitable system for two-way wireless control of digitally controlled valve actuators in a pool or spa system. The process 300 may in particular relate to two-way wireless communication between the pool automation system 102 and the valve actuator 106 from the perspective of the pool automation system 102. The process 300 may also relate to controlling positions of the valve actuator 106. In some examples, the user device may perform the process 300.

Prior to the process 300, the pool automation system 102 can first output, to the valve actuator (e.g., one of the valve actuators 106), electrical power for actuating the valve and for determining the valve position state information. Subsequently, the pool automation system 102 can receive a wireless signal including initial valve position state information. For example, each valve actuator may execute an initialization routine that takes one or more measurements (e.g., valve position indication, flow, temperature, etc.) and determines initial the valve position state. Each respective valve actuator can send this initial valve position state information via wireless signal to the pool automation system 102, prior to operations per the process 300 below. For instance, the previous position, referenced in block 302 below, can be the initial valve position.

The process 300 begins at block 302 by outputting, by the pool automation system 102 using a first wireless interface (e.g., wireless interface 116) of the pool automation system 102, a first wireless signal to a valve actuator operably connected to the valve (e.g., one of the valve actuators 106), the first wireless signal received at a second wireless interface of the valve actuator and including a position change signal configured to cause the valve actuator to actuate the valve from a previous position to a new position. The first wireless signal may be sent via a wireless interface of the pool automation system 102 and received at a wireless interface of the valve actuator. The first wireless signal may be transmitted via a wireless network that includes the two wireless interfaces.

The position change signal may include information that specifies a new position for a valve, a mode of operation for a valve, or a command to take a measurement, among other possible operations. In addition to the position change signal, the first wireless signal may include a position setting signal, a reset signal, a state signal, or any other suitable type of signal. The type of signal may indicate the type of function or response expected from the valve actuator upon the valve actuator receiving and processing the signal.

The first wireless signal may be generated in response to an input at the pool automation system and/or in an automated manner. For example, a user may interact with the pool automation system to input a command to generate the position change signal. In some examples, the user (or a routine running on the pool automation system) may select a preset function, operation, or the like, and the pool automation system may determine to send the first wireless signal.

At block 304, the process 300 includes the pool automation system receiving, from the valve actuator, by the first wireless interface of the pool automation system, a second wireless signal including valve position state information relating to the new position of the valve. The valve actuator may send the second wireless signal, which may represent a response to the first wireless signal, via the wireless interface of the valve actuator. The valve position state information may include information relating to a current position of a valve corresponding to the valve actuator. The position change signal may be configured to cause the valve actuator to actuate the valve from a previous position to the current position. In this example, after the valve actuator processes the first signal, the valve actuator may send back the second signal indicating the state of the valve actuator after processing the first signal.

In some examples, the valve actuator and associated control circuitry have absolute valve position sensing capabilities. The valve position state information can include the absolute valve position as measured by the valve actuator and associated sensors. In this respect, “absolute position sensing” refers generally to determining the valve position with respect to a fixed reference (e.g., fully open or closed), as opposed to determining a change from a previous position (e.g., relative position sensing). In this case, the pool automation system 102 can output the position change signal to the valve actuator, including target valve positions and then receive information about a new absolute valve position from the valve actuator, in response to the position change signal. The valve actuator can locally manage the execution of position changes, without any need for coordination of fine adjustments to the valve position.

However, in some examples, the pool automation system 102 can execute a first valve position change as described above with respect to blocks 302 and 304, and then later fine-tune the valve position based on received feedback. For example, the pool automation system 102 can receive, after blocks 302 and 304, a wireless signal including an indication of the new position of the valve. The new position can be measured by the valve actuator using a valve position indication mechanism such as a rotary encoder, a potentiometer, or a magnetic position sensor. The pool automation system 102 can compare the new position of the valve with the target valve position and then compute a fine valve position change based on the new position and the target valve position. The pool automation system 102 can generate a fine position change signal based on the fine valve position change output another wireless signal to the valve actuator to cause the valve actuator to actuate the valve from the new position to the target valve position. This fine adjustment may be needed when, for example, the initial position change made at block 302 does not precisely align with the target valve position due to factors such as mechanical backlash, signal latency, or environmental conditions affecting the valve actuator accuracy or precision movement or travel.

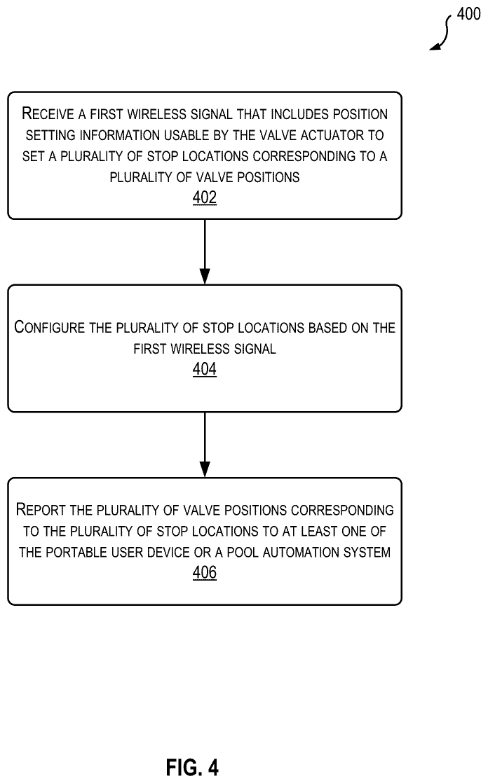

FIG. 4 shows a process 400 for configuring stop locations at a valve actuator based on user inputs, according to at least one example. The process 400 is performed by a valve actuator (e.g., the valve actuator 106 of FIG. 1). The process 400 may in particular relate to the use of a user interface to input information corresponding to configuring stop locations from the perspective of the valve actuator 106. The user interface may be presented at the user device, the valve actuator, and/or the pool automation system.

The process 400 begins at block 402 by the valve actuator receiving a first wireless signal that includes position setting information usable by the valve actuator to set a plurality of stop locations corresponding to a plurality of valve positions. The first wireless signal may be received at a wireless interface of the valve actuator. The first wireless signal may be sent by a portable user device (e.g., the user device 104) or a pool automation system (e.g., the pool automation system 102), such as the example user interface shown above in FIG. 2. The first wireless signal may be generated responsive to a user input at a user interface of the portable user device that identifies the position setting information. In some examples, the portable user device may connect to the valve actuator via a near-field wireless network such as Bluetooth.

For instance, the position setting information may include information specifying stop locations for a butterfly valve at certain angular displacements (e.g., one stop location at 30 degrees, a second stop location at 60 degrees). In some examples, the specified stop locations may be further associated with a label or other metadata. For instance, the stop location at 30 degrees may be associated with the label “one-third-open.” In general, the one or more specifications of a stop location can include a valve displacement, a predefined location, or a maximum extent, among other possibilities. The specification of a valve displacement may include the degree of rotation (e.g., 90°, 45°, or 135°), the percentage of flow allowed (e.g., 50% open), or the linear movement or travel of a valve component (e.g., 10 mm travel of a valve stem). The specification of a predefined location may include fully open, fully closed, or a preset intermediate position such as 25% open for partial flow control. In this cases, the predefined location may be preconfigured at, for example, installation time. The specification of a maximum extent may include an identification of a maximal position of the valve such as the maximum rotation angle, the maximum flow capacity, or the maximum open or closed position.

In some examples, the position change signal of block 302 of FIG. 3 can in turn be based on at least one of the one or more specifications of a stop location. For example, in lieu of specifying a particular state for the valve (e.g., 30 degrees open) or change in state (e.g., open an additional 30 degrees), the position change signal can instead reference one or more specifications of a stop location, using a label or other identifier configured with the position setting information. For instance, if the desired position for a butterfly valve is 30 degrees, then the position change signal can specify a valve position using a label such as “one-third-open” rather than determine a valve displacement needed to change the position of the valve to 30 degrees open.

In some examples in which the position change signal is based on a specification of a stop location, the position change signal can be associated with a predefined mode of operation for the pool or spa system, rather than a physical configuration of the valve. For example, the pool or spa system may have a predefined mode of operation labeled or identified as “full” or “party mode.” The pool automation system can maintain a mapping between the predefined mode of operation and a number of valve positions or stop locations. By specifying the predefined mode of operation in the position change signal, the pool automation system can cause the valve actuators to reconfigure to the specified stop locations. In some cases, the position change signal can include additional information needed for sequencing such as a specification of an ordering of valve operations or time delays.

When operating the valve by specifying a mode of operation, or other valve position identified using a label or identifier, for the pool or spa system, the pool automation system 102 can compute a valve position change based on the previous position and the target valve position and generate the position change signal based on the valve position change. For example, if the valve's previous position is fully open and the target position is 50% open, the pool automation system 102 can compute a position change of −50% and generate a corresponding position change signal to move the valve to the new position. Determining the position change signal based on a valve position change can use units of angles, linear travel, percentage of open/closed, and so on.

At block 404, the process 400 includes the valve actuator configuring the plurality of stop locations based on the first wireless signal. This may include storing information representing the plurality of stop locations in memory of the valve actuator. For examples, the position setting information may include the specification of a number of digital stop locations expressed using a suitable data structure. The position setting information may specify stop locations in absolute terms (e.g., 30% open or ½″ open) or using relative terms (e.g., open 30% more or open ½″ more). The stop locations may be associated with a human-or machine-readable label or other identifier so that the stop locations can be referenced and invoked programmatically by the pool automation system. The valve actuator can extract stop location information from the data structure and persist it in a suitable memory such as EEPROM, flash memory, or SRAM integrated into the valve actuator microprocessor.

At block 406, the process 400 includes the valve actuator reporting the plurality of valve positions corresponding to the plurality of stop locations to at least one of the portable user device or a pool automation system. For example, the position setting information may be first sent to the valve actuator, but it may be desirable to implement centralized control of the pool or spa system via the pool automation system. In that case, the position setting information, once locally persisted, can be output using, for example, a wireless signal to the pool automation system so that the configured valve positions can later be programmatically invoked. For instance, if the position setting information includes a valve position labeled “partial-flow,” associated with an absolute 30% open position of a butterfly valve, this can be reported to the pool automation system. The pool automation system can later send a position change signal including a command with the label “partial-flow” to cause the butterfly valve to adjust to the 30% open position.

In some examples, if a user were to manually adjust the location of the valve, the valve actuator may detect such manual adjustment and update state information corresponding to the current state of the valve. The valve actuator may also report this state information to the portable user device and/or the pool automation system.

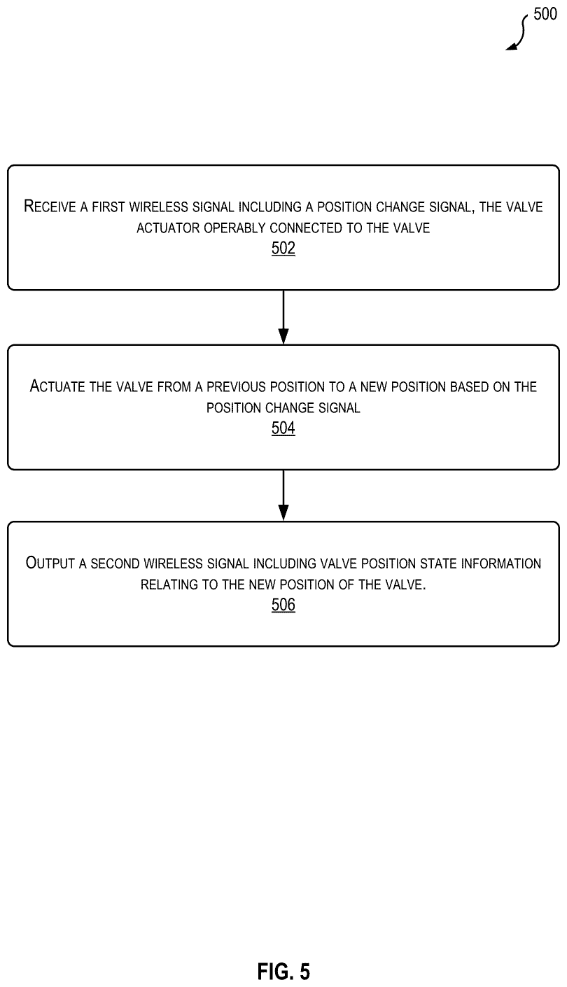

FIG. 5 shows another process 500 for two-way wireless control of digitally controlled valve actuators in a pool or spa system, according to at least one example. The process 500 is performed by a valve actuator (e.g., the valve actuator 106 of FIG. 1). The process 500 may in particular relate to two-way wireless communication between the pool automation system 102 and the valve actuator 106 from the perspective of the valve actuator 106. The process 500 may also relate to controlling the position of the valve actuator 106.

The process 500 may begin at block 502, in which a valve actuator (e.g., one of the valve actuators 106) that is operably connected to a valve, receives, from a pool automation system (e.g., pool automation system 102), a first wireless signal including a position change signal, the valve actuator. The first wireless signal may be received by a first wireless interface (e.g., one of the wireless interfaces 115) of the valve actuator. The position change signal may include information that specifies a new position for a valve, a mode of operation for a valve, or a command to take a measurement, among other possible operations, as described above with respect to block 302 of FIG. 3.

At block 504, the process 500 includes the valve actuator actuating the valve from a previous position to a new position based on the position change signal. For example, the valve actuator may include a motor that can drive the valve mechanism (e.g., the valve stem) to the new position. The valve and/or valve actuator may include position sensors (e.g., rotary encoders or potentiometers) that can provide feedback to ensure the valve movement aligns with the specified signal. In some examples, the valve may include limit switches or other internal controls that can stop the motion to prevent over-rotation or mechanical stress.

At block 506, the process 500 includes the valve actuator outputting, by the first wireless interface of the valve actuator to the pool automation system, a second wireless signal including valve position state information relating to the new position of the valve. The valve position state information may include information relating to the new position, as described above with respect to block 304 of FIG. 3.

In some examples, actuating the valve from the previous position to the new position based on the position change signal can involve making a first adjustment to a position of the valve based on the first wireless signal. The valve actuator can then determine the new position of the valve and generate the valve position state information based on the new position of the valve. For example, the valve actuator can make an initial adjustment to partially open the valve based on the first wireless signal, measure the resulting position using a rotary encoder, and generate valve position state information indicating that the valve is now 30% open.

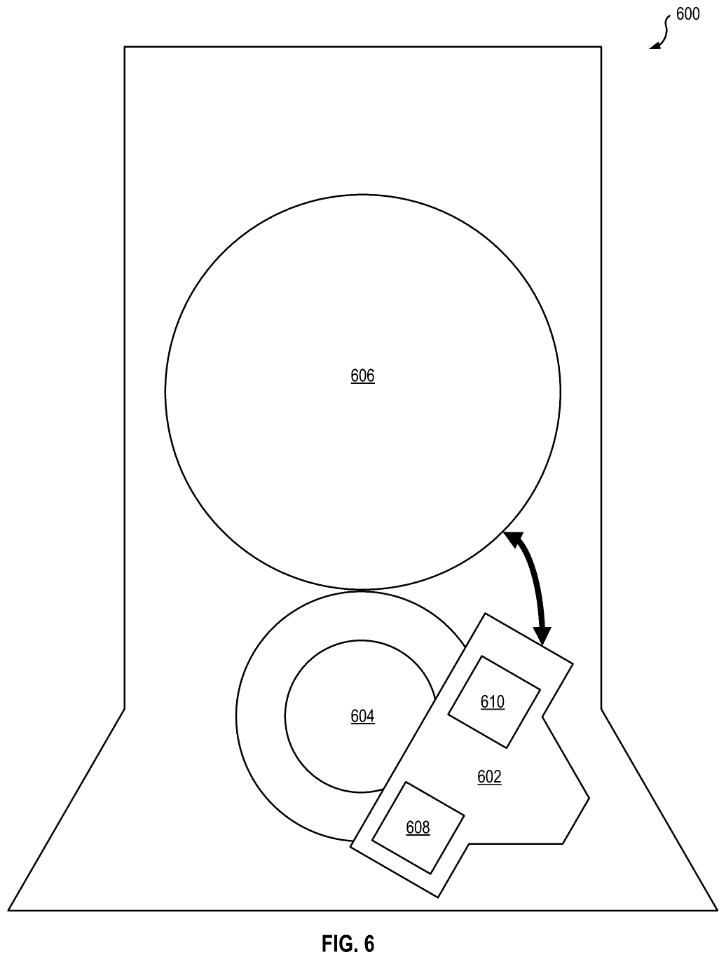

FIG. 6 illustrates a valve actuator 600 (e.g., the valve actuator 106) with a valve position sensor 602, according to at least one example. The valve position sensor 602 senses the position of a cam 604 that may be connected to a pool valve. The valve position sensor 602 may be in control of a motor 606 (e.g., mechanical actuator 110). The motor 606 may adjust the position of the cam 604, which may ultimately adjust the position of the attached pool valve. The valve position sensor 602 includes a wireless interface 608 (e.g., the wireless interface 114) for wirelessly communicating with the pool automation system 102. For example, the wireless interface 608 may be used to report position information measured by the valve position sensor 602. The valve position sensor 602 may also include microprocessor 610 (e.g., the microprocessor 112) to function as a controller for processing commands from a wirelessly connected device and implementing the commands (e.g., instructing actuation of the motor 606).

In some examples, the valve actuator 600 may have a range of at least 270 degrees to accommodate two-way valves and three-way valves. In some examples, the valve actuator 600 may have a greater range or a smaller range. The valve position sensor 602 may report the position of the cam 604, by the wireless interface 608, in response to a query or command from the pool automation system. The valve position sensor 602 may control the motor 606 to adjust the cam 604 in response to a command received by the wireless interface 608. The motor 606 may actuate either clockwise or counterclockwise in response to commands received by the wireless interface 608 and processed by the microprocessor 610. The valve position sensor 602 may sense the position of the cam 604 while actuating the motor 606 to ensure the position of the cam 604, and thus the position of an attached valve, are in line with a command received by the wireless interface 608. In alternative embodiments, the valve position sensor 602 may provide position information via the wireless interface 408 to a pool automation system. In some examples, the valve actuator 600 may include an interface by which certain inputs may be received and stored at the valve actuator 401. For example, a user may select one or more preset positions from the interface, which may be assigned to one or more preset functions/operations of the pool and/or spa system. As also described herein, in some examples, such information may be received via a user interface displayed on a portable user device, such as the example user interface of FIG. 2.

This non-limiting example is included to illustrate certain concepts. The systems and methods according to this disclosure can apply to a variety of valve actuator implementations in addition to the example described above.

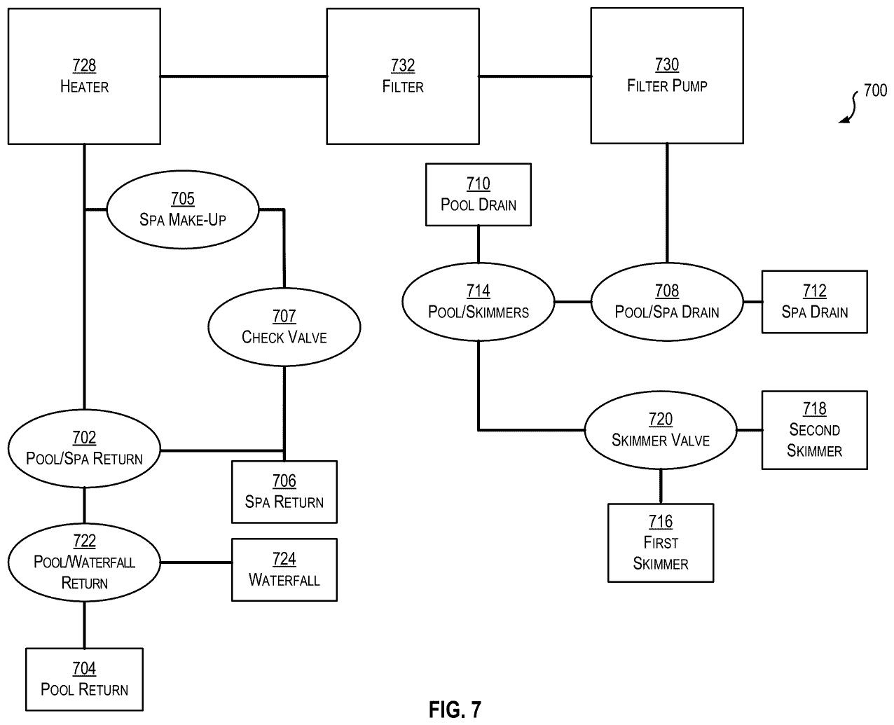

FIG. 7 illustrates an exemplary pool plumbing layout 700, according to at least one example. The pool plumbing layout 700 includes five 3-way valves: a pool/spa return valve 702 for balancing water into a pool return 704 or a spa return 706, a pool/spa drain valve 708 for balancing water out of a pool drain 710 or a spa drain 712, a pool/skimmer valve 714 for balancing water out of the pool drain 710 or into skimmers 716, 718, a skimmer valve 720 for balancing water into either a first skimmer 716 or a second skimmer 718, and a pool/waterfall return valve 722 for balancing water flowing into either the pool return 704 or a waterfall feature 724. The pool plumbing layout 700 also includes a 2-way valve for regulating water flow into the spa return 706 and a 1-way check valve 726 for preventing reverse flow into the spa return 706. The spa return 706, waterfall 724, and pool return 704 are ultimately fed by a heater 728. The pool drain 710, spa drain 712, first skimmer 716, and second skimmer 718 ultimately flow into the filter pump 730. The filter pump 730 supplies the filter 732 and drives water back to the heater 728. The components in FIG. 7 are for illustration only and fewer or additional components may be included.

The pool/spa return valve 702, the pool/spa drain valve 708, and the pool/waterfall return valve 722 may be controlled by remotely-operable, digital valve actuators, such as the valve actuator 106 of FIG. 1. The pool/spa return valve 702, the pool/spa drain valve 708, and the pool/waterfall return valve 722 may be controlled by a digital valve actuator to achieve certain outcomes desired by a user. For example, the pool/spa return valve 702 and the pool/spa drain valve 708 may bias towards providing the spa return 706 with more water to allow for a spillover effect. In another example, the pool/waterfall return valve 722 may be biased to adjust the output of the waterfall 724, where the waterfall returns into a pool. The digital valve actuators connected with the pool/spa return valve 702, the pool/spa drain valve 708, and the pool/waterfall return valve 722 may either have preprogrammed set-points determined at the time of installation to achieve desired outcomes or may sense water flow through the pool/spa return valve 702, the pool/spa drain valve 708, and the pool/waterfall return valve 722 to determine if an outcome is being achieved or has been achieved.

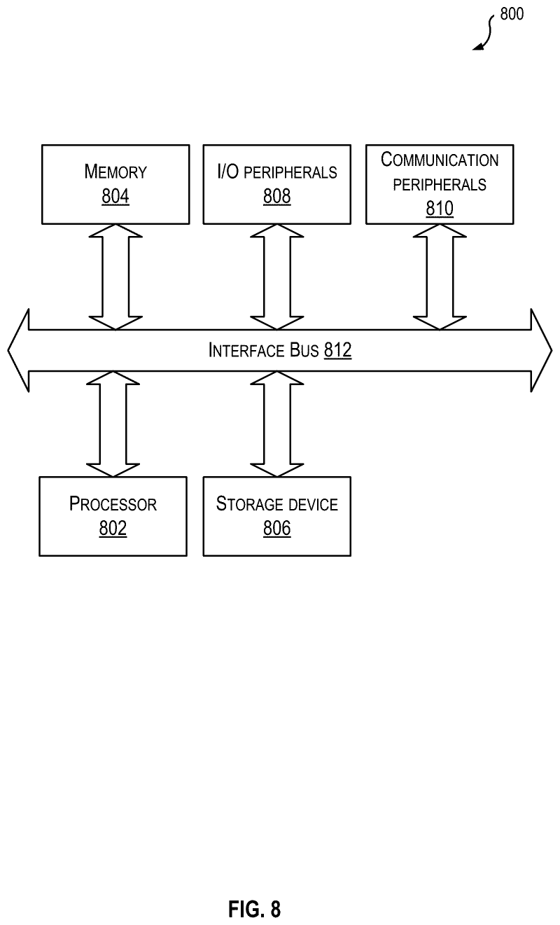

FIG. 8 illustrates examples of components of a computer system 800, according to at least one example. The computer system 800 may be a single computer such as a user computing device and/or may represent a distributed computing system such as one or more server computing devices. The computer system 800 is an example of the external computing devices, controllers and/or microcontrollers of pool components and/or the pool automation system 101, and the like.

The computer system 800 may include at least a processor 802, a memory 804, a storage device 806, input/output peripherals (I/O) 808, communication peripherals 810, and an interface bus 812. The interface bus 812 is configured to communicate, transmit, and transfer data, controls, and commands among the various components of the computer system 800. The memory 803 and the storage device 806 include computer-readable storage media, such as Random Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media may be configured to store instructions or program code embodying aspects of the disclosure. The memory 804 and the storage device 806 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that may communicate, propagate, or transport a program for use in connection with the computer system 800.

Further, the memory 804 may include an operating system, programs, and applications. The processor 802 is configured to execute the stored instructions and includes, for example, a logical processing unit, a microprocessor, a wireless signal processor, and other processors. The memory 804 and/or the processor 802 may be virtualized and may be hosted within another computing system of, for example, a cloud network or a data center. The I/O peripherals 808 may include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 808 are connected to the processor 802 through any of the ports coupled to the interface bus 812. The communication peripherals 810 are configured to facilitate communication between the computer system 800 and other computing devices over a communications network and include, for example, a network inference controller, modem, wireless and wired interface cards, wireless transmitter, and other communication peripherals.

### General Considerations

The examples described herein are not intended to be mutually exclusive, exhaustive, or restrictive in any way, and the disclosure is not limited to these example embodiments but rather encompasses all possible modifications and variations within the scope of any claims ultimately drafted and issued in connection with the disclosure (and their equivalents). For avoidance of doubt, any combination of features not physically impossible or expressly identified as non-combinable herein may be within the scope of the disclosure. Finally, references to “pools” and “swimming pools” herein may also refer to spas or other water containing vessels used for recreation, training, or therapy.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Although applicant has described devices and techniques for use principally with swimming pools and spas, persons skilled in the relevant field will recognize that the present invention may be employed in connection with other objects and in other manners. Finally, references to “pools” and “swimming pools” herein may also refer to spas or other water containing vessels used for recreation or therapy and for which cleaning is needed or desired.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

### EXAMPLES

A collection of exemplary embodiments is provided below, including at least some explicitly enumerated as “Examples” providing additional description of a variety of example embodiments in accordance with the concepts described herein. These examples are not meant to be mutually exclusive, exhaustive, or restrictive; and the disclosure is not limited to these examples but rather encompasses all possible modifications and variations within the scope of the issued claims and their equivalents.

As used below, any reference to a series of examples is to be understood as a reference to each of those examples disjunctively (e.g., “Examples 1-4” is to be understood as “Examples 1, 2, 3, or 4”).

Example 1 is a method for actuating a valve included in a pool or spa system, comprising: outputting, by a pool automation system using a first wireless interface of the pool automation system, a first wireless signal to a valve actuator operably connected to the valve, the first wireless signal received at a second wireless interface of the valve actuator and comprising a position change signal configured to cause the valve actuator to actuate the valve from a previous position to a new position; and receiving, from the valve actuator, by the first wireless interface of the pool automation system, a second wireless signal comprising valve position state information relating to the new position of the valve.

Example 2 is the method of example(s) 1, further comprising: receiving, by the pool automation system, position setting information including one or more specifications of a stop location, wherein: the one or more specifications of a stop location include at least one of a valve displacement, a predefined location, or a maximum extent; and the position change signal is based on at least one of the one or more specifications of a stop location.

Example 3 is the method of any one or more of the above examples, wherein the position setting information is input using a portable user device.

Example 4 is the method of any one or more of the above examples, wherein: the position change signal is based on a first specification of a stop location; and the position change signal is associated with a predefined mode of operation for the pool or spa system.

Example 5 is the method of any one or more of the above examples, further comprising: outputting, by the pool automation system to the valve actuator, electrical power for actuating the valve and for determining the valve position state information; and receiving, by the first wireless interface of the pool automation system from the valve actuator, a third wireless signal comprising initial valve position state information for an initial position, wherein the previous position is the initial valve position.

Example 6 is the method of any one or more of the above examples, further comprising: determining a target valve position for the valve based on a mode of operation for the pool or spa system; computing a valve position change based on the previous position and the target valve position; and generating the position change signal based on the valve position change.

Example 7 is the method of any one or more of the above examples, further comprising: receiving, by the first wireless interface of the pool automation system from the valve actuator, a third wireless signal comprising an indication of the new position of the valve; comparing the new position of the valve with the target valve position; computing a fine valve position change based on the new position and the target valve position; generating a second position change signal based on the fine valve position change; and outputting, by the pool automation system using the first wireless interface, a fourth wireless signal to the valve actuator, the fourth wireless signal received at the second wireless interface of the valve actuator and comprising the second position change signal configured to cause the valve actuator to actuate the valve from the new position to the target valve position.

Example 8 is a pool automation system for controlling a valve position of a valve included in a pool or spa system, comprising: a first wireless interface; one or more non-transitory computer-readable media; and one or more processors communicatively coupled to the one or more non-transitory computer-readable media, the one or more processors configured to execute processor-executable instructions stored in the non-transitory computer-readable media to perform operations including: outputting, using the first wireless interface, a first wireless signal to a valve actuator operably connected to the valve, the first wireless signal received at a second wireless interface of the valve actuator and comprising a position change signal configured to cause the valve actuator to actuate the valve from a previous position to a new position; and receiving, from the valve actuator, by the first wireless interface, a second wireless signal comprising valve position state information relating to the new position of the valve.

Example 9 is the pool automation system of example(s) 8, the operations further including: receiving position setting information including one or more specifications of a stop location, wherein the position setting information is input using a portable user device: the one or more specifications of a stop location include at least one of a valve displacement, a predefined location, or a maximum extent; and the position change signal is based on at least one of the one or more specifications of a stop location.

Example 10 is the pool automation system of any one or more of the above examples, wherein: the position change signal is based on a first specification of a stop location; and the position change signal is associated with a predefined mode of operation for the pool or spa system.

Example 11 is the pool automation system of any one or more of the above examples, the operations further including: outputting, to the valve actuator, electrical power for actuating the valve and for determining the valve position state information; and receiving, by the first wireless interface from the valve actuator, a third wireless signal comprising initial valve position state information for an initial position, wherein the previous position is the initial valve position.

Example 12 is the pool automation system of any one or more of the above examples, the operations further including: determining a target valve position for the valve based on a mode of operation for the pool or spa system; computing a valve position change based on the previous position and the target valve position; and generating the position change signal based on the valve position change.

Example 13 is the pool automation system of any one or more of the above examples, the operations further including: receiving, by the first wireless interface from the valve actuator, a third wireless signal comprising an indication of the new position of the valve; comparing the new position of the valve with the target valve position; computing a fine valve position change based on the new position and the target valve position; and generating a second position change signal based on the fine valve position change; and outputting, using the first wireless interface, a fourth wireless signal to the valve actuator, the fourth wireless signal received at the second wireless interface of the valve actuator and comprising the second position change signal configured to cause the valve actuator to actuate the valve from the new position to the target valve position.

Example 14 is a method for actuating a valve included in a pool or spa system, comprising: receiving, by a first wireless interface of a valve actuator from a pool automation system, a first wireless signal comprising a position change signal, the valve actuator operably connected to the valve; actuating the valve from a previous position to a new position based on the position change signal; and outputting, by the first wireless interface of the valve actuator to the pool automation system, a second wireless signal comprising valve position state information relating to the new position of the valve.

Example 15 is the method of example(s) 14, wherein the position change signal is based on at least one of one or more specifications of a stop location, the one or more specifications of a stop location including at least one of a valve displacement, a predefined location, or a maximum extent.

Example 16 is the method of any one or more of the above examples, further comprising: receiving, by the valve actuator from the pool automation system, electrical power for actuating the valve and for determining the valve position state information; and outputting, to the pool automation system by the first wireless interface of the valve actuator, a third wireless signal comprising initial valve position state information for an initial position, wherein the previous position is the initial valve position.

Example 17 is the method of any one or more of the above examples, wherein actuating the valve from the previous position to the new position based on the position change signal comprises: adjusting a position of the valve based on the first wireless signal; determining the new position of the valve; and generating the valve position state information based on the new position of the valve.

Example 18 is the method of any one or more of the above examples, further comprising: determining the new position of the valve; outputting, by the first wireless interface to the pool automation system, an indication of the new position of the valve; receiving, by the first wireless interface from the pool automation system, a third wireless signal comprising a fine position change signal based on a difference between the new position of the valve and a target valve position; adjusting a position of the valve based on the third wireless signal; determining a final position of the valve; and outputting, by the first wireless interface to the pool automation system, a second indication of the final position of the valve.

Example 19 is the method of any one or more of the above examples, wherein the position change signal is determined based on an indication of a target valve position received by the pool automation system from a portable user device.

Example 20 is the method of any one or more of the above examples, further comprising: receiving, by the first wireless interface from the pool automation system, a third wireless signal including position setting information usable by the valve actuator to set a plurality of stop locations; determining a plurality of valve positions based on the plurality of stop locations; configuring the plurality of stop locations based on the third wireless signal, comprising storing information representing the plurality of stop locations in a memory of the valve actuator; and outputting, by the first wireless interface to the pool automation system, a fourth wireless signal comprising the plurality of valve positions corresponding to the plurality of stop locations.

What is claimed is:

1. A method for actuating a valve included in a pool or spa system, comprising:
outputting, by a pool automation system using a first wireless interface of the pool automation system, a first wireless signal to a valve actuator operably connected to the valve, the first wireless signal received at a second wireless interface of the valve actuator and comprising a position change signal configured to cause the valve actuator to actuate the valve from a previous position to a new position; and
receiving, from the valve actuator, by the first wireless interface of the pool automation system, a second wireless signal comprising valve position state information relating to the new position of the valve.

2. The method of claim 1, further comprising:
receiving, by the pool automation system, position setting information including one or more specifications of a stop location, wherein:
the one or more specifications of a stop location include at least one of a valve displacement, a predefined location, or a maximum extent; and
the position change signal is based on at least one of the one or more specifications of a stop location.

3. The method of claim 2, wherein the position setting information is input using a portable user device.

4. The method of claim 2, wherein:
the position change signal is based on a first specification of a stop location; and
the position change signal is associated with a predefined mode of operation for the pool or spa system.

5. The method of claim 1, further comprising:
outputting, by the pool automation system to the valve actuator, electrical power for actuating the valve and for determining the valve position state information; and
receiving, by the first wireless interface of the pool automation system from the valve actuator, a third wireless signal comprising initial valve position state information for an initial valve position, wherein the previous position is the initial valve position.

6. The method of claim 1, further comprising:
determining a target valve position for the valve based on a mode of operation for the pool or spa system;
computing a valve position change based on the previous position and the target valve position; and
generating the position change signal based on the valve position change.

7. The method of claim 6, further comprising:
receiving, by the first wireless interface of the pool automation system from the valve actuator, a third wireless signal comprising an indication of the new position of the valve;
comparing the new position of the valve with the target valve position;
computing a fine valve position change based on the new position and the target valve position;
generating a second position change signal based on the fine valve position change; and
outputting, by the pool automation system using the first wireless interface, a fourth wireless signal to the valve actuator, the fourth wireless signal received at the second wireless interface of the valve actuator and comprising the second position change signal configured to cause the valve actuator to actuate the valve from the new position to the target valve position.

8. A pool automation system for controlling a valve position of a valve included in a pool or spa system, comprising:
a first wireless interface;
one or more non-transitory computer-readable media; and
one or more processors communicatively coupled to the one or more non-transitory computer-readable media, the one or more processors configured to execute processor-executable instructions stored in the non-transitory computer-readable media to perform operations including:
outputting, using the first wireless interface, a first wireless signal to a valve actuator operably connected to the valve, the first wireless signal received at a second wireless interface of the valve actuator and comprising a position change signal configured to cause the valve actuator to actuate the valve from a previous position to a new position; and
receiving, from the valve actuator, by the first wireless interface, a second wireless signal comprising valve position state information relating to the new position of the valve.

9. The pool automation system of claim 8, the operations further including:
receiving position setting information including one or more specifications of a stop location, wherein the position setting information is input using a portable user device:
the one or more specifications of a stop location include at least one of a valve displacement, a predefined location, or a maximum extent; and
the position change signal is based on at least one of the one or more specifications of a stop location.

10. The pool automation system of claim 9, wherein:
the position change signal is based on a first specification of a stop location; and
the position change signal is associated with a predefined mode of operation for the pool or spa system.

11. The pool automation system of claim 8, the operations further including:
outputting, to the valve actuator, electrical power for actuating the valve and for determining the valve position state information; and
receiving, by the first wireless interface from the valve actuator, a third wireless signal comprising initial valve position state information for an initial valve position, wherein the previous position is the initial valve position.

12. The pool automation system of claim 8, the operations further including:
determining a target valve position for the valve based on a mode of operation for the pool or spa system;
computing a valve position change based on the previous position and the target valve position; and
generating the position change signal based on the valve position change.

13. The pool automation system of claim 12, the operations further including:
receiving, by the first wireless interface from the valve actuator, a third wireless signal comprising an indication of the new position of the valve;
comparing the new position of the valve with the target valve position;
computing a fine valve position change based on the new position and the target valve position; and
generating a second position change signal based on the fine valve position change; and
outputting, using the first wireless interface, a fourth wireless signal to the valve actuator, the fourth wireless signal received at the second wireless interface of the valve actuator and comprising the second position change signal configured to cause the valve actuator to actuate the valve from the new position to the target valve position.

14. A method for actuating a valve included in a pool or spa system, comprising:
receiving, by a first wireless interface of a valve actuator from a pool automation system, a first wireless signal comprising a position change signal, the valve actuator operably connected to the valve;
actuating the valve from a previous position to a new position based on the position change signal; and
outputting, by the first wireless interface of the valve actuator to the pool automation system, a second wireless signal comprising valve position state information relating to the new position of the valve.

15. The method of claim 14, wherein the position change signal is based on at least one of one or more specifications of a stop location, the one or more specifications of a stop location including at least one of a valve displacement, a predefined location, or a maximum extent.

16. The method of claim 14, further comprising:
receiving, by the valve actuator from the pool automation system, electrical power for actuating the valve and for determining the valve position state information; and
outputting, to the pool automation system by the first wireless interface of the valve actuator, a third wireless signal comprising initial valve position state information for an initial valve position, wherein the previous position is the initial valve position.

17. The method of claim 14, wherein actuating the valve from the previous position to the new position based on the position change signal comprises:
adjusting a position of the valve based on the first wireless signal;
determining the new position of the valve; and
generating the valve position state information based on the new position of the valve.

18. The method of claim 14, further comprising:
determining the new position of the valve;
outputting, by the first wireless interface to the pool automation system, an indication of the new position of the valve;
receiving, by the first wireless interface from the pool automation system, a third wireless signal comprising a fine position change signal based on a difference between the new position of the valve and a target valve position;
adjusting a position of the valve based on the third wireless signal;
determining a final position of the valve; and
outputting, by the first wireless interface to the pool automation system, a second indication of the final position of the valve.

19. The method of claim 14, wherein the position change signal is determined based on an indication of a target valve position received by the pool automation system from a portable user device.

20. The method of claim 14, further comprising:
receiving, by the first wireless interface from the pool automation system, a third wireless signal including position setting information usable by the valve actuator to set a plurality of stop locations;
determining a plurality of valve positions based on the plurality of stop locations;
configuring the plurality of stop locations based on the third wireless signal, comprising storing information representing the plurality of stop locations in a memory of the valve actuator; and
outputting, by the first wireless interface to the pool automation system, a fourth wireless signal comprising the plurality of valve positions corresponding to the plurality of stop locations.
